(19) United States
(12) Patent Application Publication
(10) Pub. No.: US 2016/0005323 A1
(43) Pub. Date: Jan. 7, 2016

(54) ADAPTIVE E-LEARNING SYSTEM AND METHOD

(71) Applicant: Mentorum Solutions Inc., Montreal (CA)

(72) Inventors: Roger NKAMBOU, Montreal (CA); Komi SODOKE, Brossard (CA); Mohamed HACENE, Montreal (CA)

(21) Appl. No.: 14/791,328

(22) Filed: Jul. 3, 2015

Related U.S. Application Data
(60) Provisional application No. 62/020,633, filed on Jul. 3, 2014.

(51) Int. Cl. G09B 7/00; G06N 5/04

(52) U.S. Cl. CPC G09B 7/00; G06N 5/04

(57) ABSTRACT

An adaptive computer-implemented e-learning system and method able to deliver a learning approach that customizes and adapts to each learners' skills and knowhow. A computer-implemented cognitive diagnosis process for predictions on skills and knowledge of a learner comprising the steps of: building a domain ontology; establishing a items bank; referencing the items bank using elements from the domain ontology elements (semantic-grounding of the items); establishing a training database of learners answers; estimating Cognitive Diagnostic Model (CDM) parameters and determining an appropriate model to be used; running the model to estimate a learner level on non-abstract latent variables; applying a Mastery of domain Knowledge and competency Skill (MKS) approach to estimate the learner level on abstract latent variables, or extracting relevant hierarchies from the ontology and use the CDM appropriate model to estimate those attributes; and building a diagnosis report from the results of steps 6) and 7).

### CROSS-REFERENCE TO RELATED APPLICATIONS

The present patent application claims the benefits of priority of commonly assigned U.S. Provisional Patent Application No. 62/020,633, entitled “Adaptive e-learning system and method” and filed at the U.S. Patent and Trademark Office on Jul. 3, 2014, the content of which is incorporated herein by reference.

### FIELD OF THE INVENTION

The present invention relates to the field of education and training. More particularly, the invention relates to an adaptive computerized e-learning system and method able to deliver a learning approach that customizes and adapts to each learners' skills and knowhow.

### BACKGROUND

The traditional cookie cutter approach to learning is no longer sufficient enough to respond to the learners' needs of today. Learners want to take the optimal path to achieve their learning objectives in the shortest amount of time.

Cognitive Diagnosis Models (CDM) approaches are used for estimating a state of knowledge and skills of a learner such as a student and offer the opportunity to provide feedback with respect to the strengths and weaknesses of the latter according to the skills tested. In addition, Intelligent Tutoring Systems (ITS) can actively diagnose the knowledge of the learner based on a learning model that he or she maintains throughout a learning process rather than solely based on answers to questions. However the ITS requires a user to maintain his learning model and such practice requires additional effort and additional input from the user.

Therefore, there is a need to provide a learning approach that customizes and adapts to each learners' skills and knowhow in an efficient manner.

### SUMMARY OF THE INVENTION

The aforesaid and other objectives of the present invention are realized by generally providing an adaptive computer-implemented learning or e-learning system and method in order to allow a learner to collaborate in an educational process.

Another object of the present invention is to provide an adaptive computerized learning or e-learning system and method in order to target each learner's specific needs.

Another object of the present invention is to provide an adaptive computerized learning or e-learning system and method in order to guide a learner to excel while significantly reducing training time and cost.

Another object of the present invention is to provide a blended learning methodology that keeps a human element of a coach/tutor/mentor and yet increases a learning potential in a cost effective manner.

According to one aspect of the invention, there is provided a system (for example LINGUATRACK™), which relies on three interrelated mechanisms: a cognitive diagnosis, recommending activities and automated composition of learning modules.

According to one aspect of the invention, there is provided an online learning material presentation and sequence that adapts according to students' learning needs based on their responses to questions.

According to one aspect of the invention, there is provided an adaptive learning system to provide an adaptive training path according to a cognitive diagnostic established according a user input. In one embodiment, the user input is an answer that a user provided in a questionnaire or a skill test.

According to one aspect of the invention, there is provided an adaptive learning method that collects a user input indicative of a user's knowledge base, establishes a cognitive diagnostic according to the user input and automatically determines a training path based on the cognitive diagnostic.

According to one aspect of the invention, there is provided a server adapted to dynamically provide a cognitive diagnostic according to a user response to a questionnaire, the questionnaire being developed to evaluate a user's knowledge level. According to one embodiment, the cognitive diagnostic is established according to a matrix.

According to one aspect of the invention, there is provided a server adapted to dynamically determine training modules according to a cognitive diagnostic related to a user. According to one embodiment, the cognitive diagnostic is related to a user knowledge evaluation corresponding to a previous training module.

According to one aspect of the invention, there is provided a device adapted to receive from a server information indicative of a training module selected according to a cognitive diagnostic related to a user.

According to one aspect of the invention, there is provided a system for a coordinator to provide coaching to a student, define various training paths, and establish cognitive diagnostic criteria's.

According to one aspect of the invention, it is provided a computer-implemented cognitive diagnosis process for predictions on skills of knowledge of a learner, the process comprising the following steps:
1) building a domain ontology;
2) establishing a items bank;
3) referencing the items bank using elements from the domain ontology elements or semantic-grounding of the items;
4) establishing a training database of learners answers;
5) estimating Cognitive Diagnostic Model (CDM) parameters and determining an appropriate model to be used;
6) running the model to estimate a learner level on non-abstract latent variables;
7) applying a Mastery of domain Knowledge and competency Skill (MKS) approach to estimate the learner level on abstract latent variables, or extracting relevant hierarchies from the ontology and use the CDM appropriate model to estimate those attributes; and
8) building a diagnosis report from the results of steps 6) and 7).

Other features and advantages of the present invention will be better understood upon reading of preferred embodiments thereof, with reference to the appended drawings.

### BRIEF DESCRIPTION OF DRAWINGS

FIG. 1 is a block diagram of an adaptive leaning server to which are connected instructor devices and student devices through a network, according to one embodiment;

FIG. 2 is a diagram of an adaptive learning method that collects a user input, establishes a cognitive diagnostic and automatically determines a training path, according to one embodiment;

FIG. 3 is a screen snapshot of a user knowledge evaluation interface, according to one embodiment (Aquila preliminary test user interface);

FIG. 4 is an illustration of a data structure representing an example of a “French as a Second Language” ontology, according to one embodiment;

FIG. 5 is a screen snapshot of an instructor device user interface (ex.: Mentorum interface);

FIG. 6 is a screen snapshot of a student device user interface (ex.: Mentorum interface);

FIG. 7 is a screen snapshot of a training path, according to one embodiment (ex.: Mentorum interface);

FIG. 8 is a screen snapshot of a client (ie. company) device user interface (Mentorum Interface);

FIG. 9 is a screen snapshot of a learner device user gamification interface (Linguatrack iOS mobile Interface), according to one embodiment;

FIG. 10 is a screen snapshot of a learner device user chatting interface (Linguatrack iOS mobile Interface), according to one embodiment;

FIG. 11 is a screen snapshot of a learner device user notification interface (Linguatrack iOS mobile Interface), according to one embodiment;

FIG. 12 is an illustration of a matrix of dimension J×K corresponding to J items and K attributes of the domain, according to one embodiment;

FIG. 13 is an illustration of the probabilities associated to each cognitive profile class, according to one embodiment; and

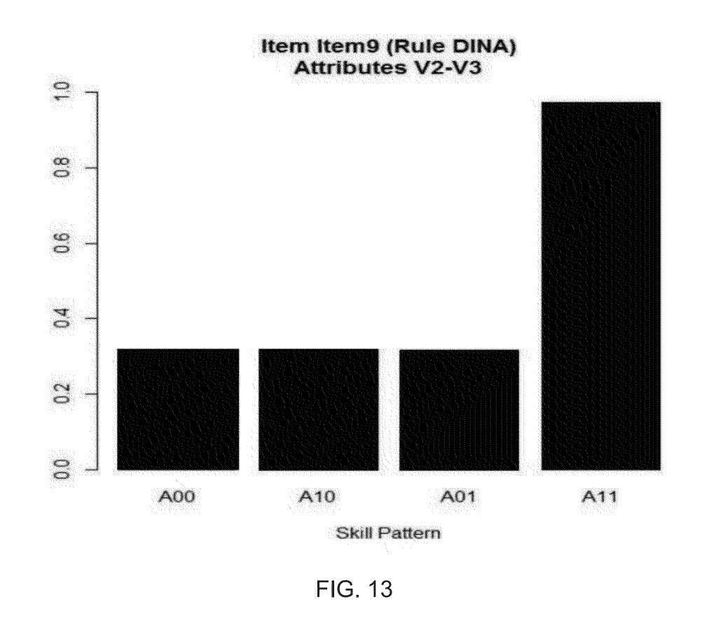

FIG. 14 is an illustration of software tool components of an e-Learning environment, according to one embodiment, such as Aquila Tool Suite;

FIG. 15 is an illustration of all software sub-components that interact with the Aquila Data.

In the following description, similar features in the drawings have been given similar reference numerals and in order to lighten the figures, some elements are not referred to in some figures if they were already identified in a preceding figure.

### DETAILED DESCRIPTION OF PREFERRED EMBODIMENTS

The present approach is based on the use of interactive and multimedia resources using multiple distribution channels (ex.: web, mobile, etc) in order to provide an adaptive training methodology based on a cognitive profile and knowledge level of a learner.

The present further provides a learning management system for a learner and allows the learner to access the learning management system through the web or specialized mobile applications developed for this purpose.

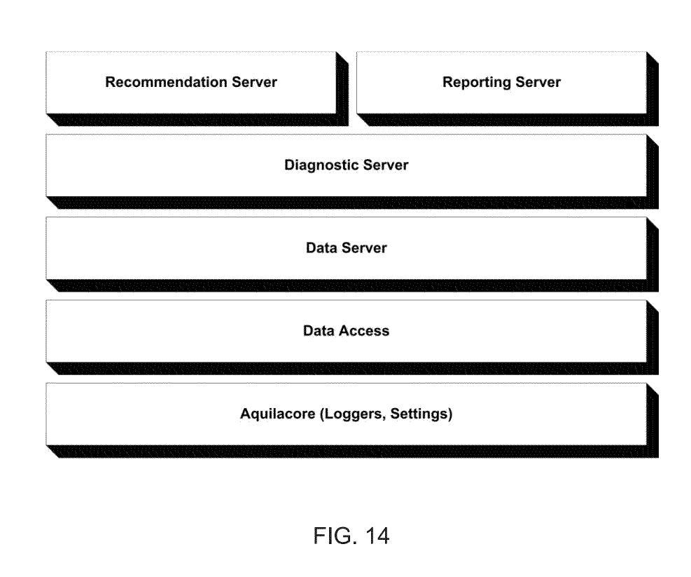

The present further relates to a service-based framework, herein referred to as “Aquila™”, adapted to provide at least three services: learning adaptation, cognitive diagnosis and smart learning objects recommendation. Each of these services is implemented through an approach and technique integrated in the Aquila-Tool-Suite (Aquila-TS), as presented in FIG. 14.

According to one embodiment, at a beginning of a training, a learner is associated to a coach or tutor who will follow him throughout his entire training period via regular video-based face-to-face or telephone coaching sessions. The coach can track the progress and results of the learner's activities with a portal and in some cases, the coach can track the progress and results of multiple learners with the portal. Interaction between learners and coaches is thereby achieved in order to provide a enhanced learning experience and an increased user motivation in his training.

### Adaptive Learning Engine

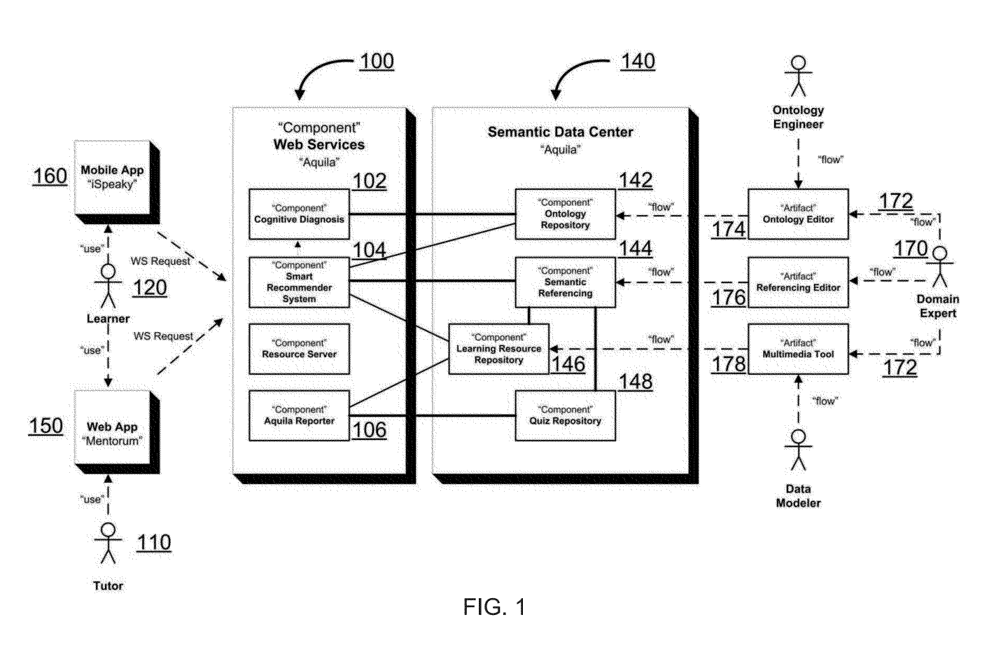

Presented in FIG. 1 is a block diagram of an adaptive learning engine 100 to which are connected via a network instructor devices 110 and student devices 120, according to one embodiment. The adaptive learning engine 100, herein referred to by “Aquila™”, delivers a personalized learning experience. The engine 100 has a cognitive diagnostic module 102 adapted to access and discover a learner's strengths and weaknesses in order to establish a diagnostic. The engine 100 further has a recommendation module 104 adapted to determine a learning path based on a learner's unique needs, skills and objectives according to the diagnostic established by cognitive diagnostic module 102. In addition, the engine 100 has a reporting service 106 adapted to build a diagnostic report according to the established diagnostic. The report may be used by a tutor in order to prepare a recommendation to the learner.

In one embodiment, a learner is asked questions and based on his answers, the system calculates his degree of mastery of a concept and the cognitive diagnostic module 102 establishes a diagnostic. The recommendation module 104 uses the diagnostic to assess the learner's mastery of specific knowledge and skills in order to automatically select or determine the next level of training and training content.

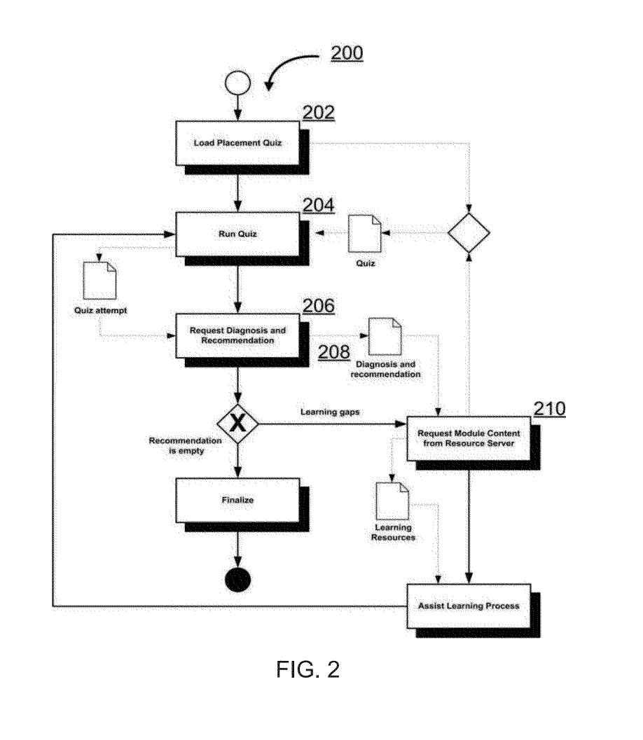

Presented in FIG. 2 is a diagram of an adaptive learning method 200, according to one embodiment. The method 200 consists of loading a quiz 202, executing a quiz 204, establishing a diagnostic 206, determining a training recommendation 208 according to the diagnostic and providing a training content 210 according to the training recommendation.

In one embodiment, the method 200 includes loading a quiz 202 according to a previously provided training content 210.

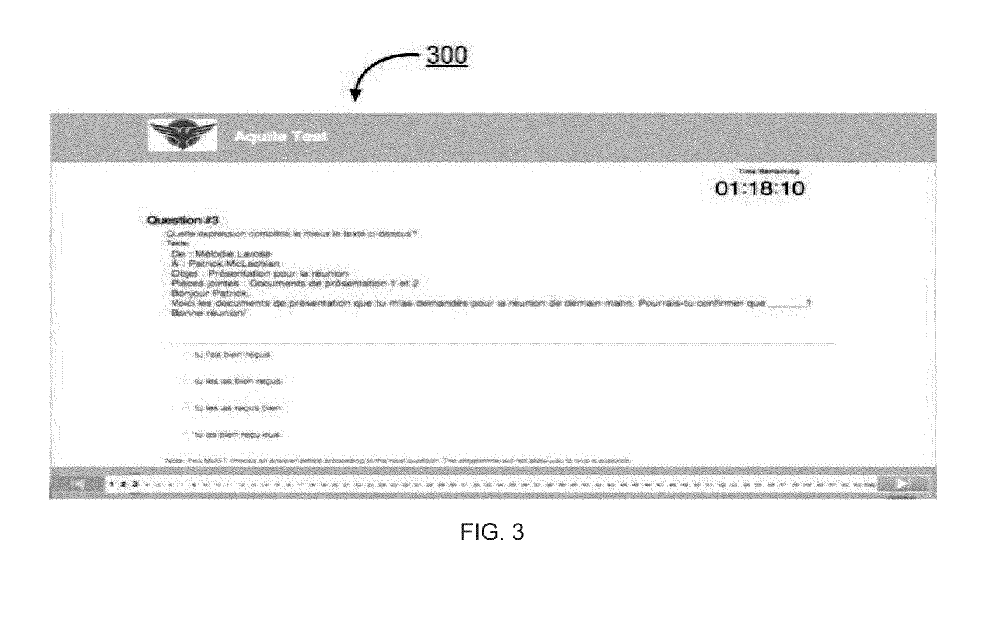

Presented in FIG. 3 is a screen snapshot of a user knowledge evaluation interface 300, according to one embodiment. In one embodiment, the knowledge evaluation interface is a quiz interface such as the Aquila preliminary test interface.

### Ontology

Returning to FIG. 1, the system further includes an ontology module 140. The ontology module 140 has a data structure module 142 which is an ontology repository, a semantic referencing module 144, a learning resource repository module 146 and a quiz repository module 148. The ontology module 140 represents an exhaustive network of concepts, with the knowledge of name and the relationships between them. Each concept is indexed and tagged to specific learning activities.

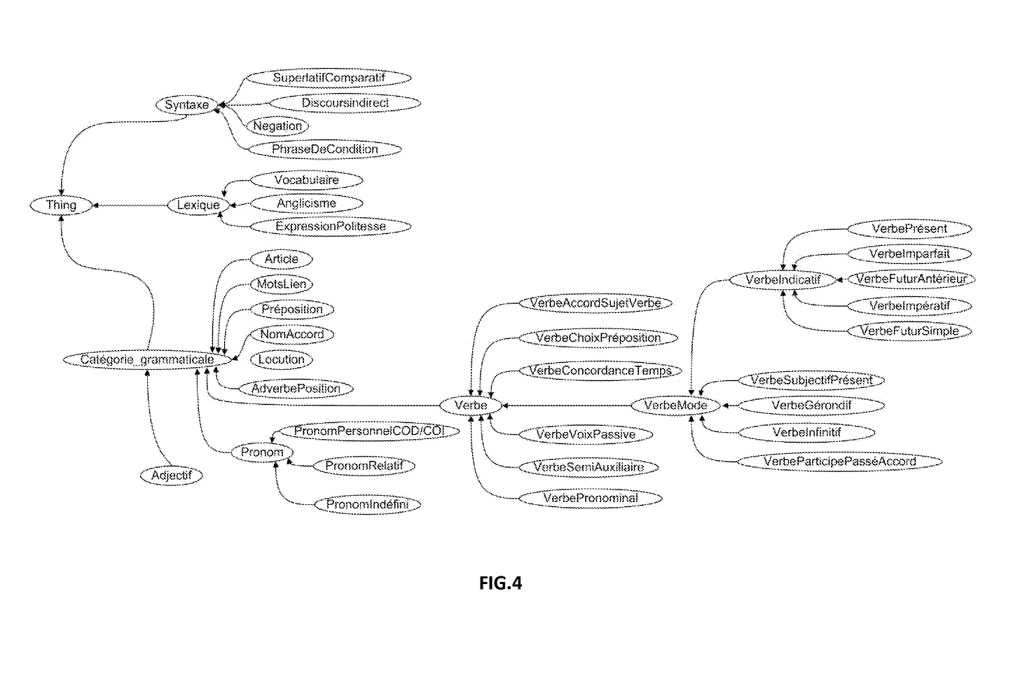

Presented in FIG. 4 is a data structure 142 representing a French as a Second Language ontology, according to one embodiment.

According to one embodiment, an explicit domain ontology is linked to items and used in the Aquila Cognitive Diagnosis Service by the cognitive diagnostic module 102. Thereby, Aquila's cognitive diagnosis process is deeply semantically-grounded and leads to deep and fine-grain predictions on learner skills and knowledge. In one instance, the process follows steps described as follows:
1) Building the domain ontology
2) Establishing the items bank
3) Referencing the items bank using the domain ontology elements (semantic-grounding of the items)
4) Establishing a training database of learners answers
5) Estimating the Cognitive Diagnostic Model (CDM) parameters and Determining the appropriate model to be used
6) Running the model to estimate the learner level on non-abstract latent variables
7) Applying the MKS approach to estimate the learner level on abstract latent variables (or extract relevant hierarchies from the ontology and use the CDM appropriate model to estimate those attributes)
8) Building the diagnosis report from the results of steps 6) and 7).

### Learning Management System

Returning to FIG. 1, the system includes a web-based learning management application 150, herein referred to by “Mentorum™”. Both the tutor 110 and the learner 120 can access the management application 150 via a network in order to communicate. This way, the tutor 110 can provide some advice to a learner 120 and the learner 120 can consult the tutor 110 concerning a question. The learning management application 150 is an adaptive e-coaching and training platform that offers an effective blended learning methodology. According to one embodiment, the learning management application 150 is an online platform that offers users a personalized fast on-the-go learning tool and in-depth training by providing access to coaches for real-time exchange and advice.

In addition, the adaptive learning engine 100 transmits information to the learning management application 150. The engine 100 provides to the application 150 a cognitive profile of a learner based on detected learner level of competencies, strength and weaknesses via an adaptive placement test. The engine 100 further provides to the application 150 a customized learning path according to learning objects provided by the tutor, online via the application 150. The learner's training objectives and modules can thus be constantly readjusted according to his progress through the training.

According to one embodiment, the application 150 offers a flexible and customizable user interface that gives all stakeholders (learners, coaches, clients and clients, i.e. companies) access to a personalized dashboard where all relevant training information such as interactive training content and courses, motivational tools and so on are available.

According to yet another embodiment, the application 150 is adapted to provide an advanced progress tracking dashboard that allows coaches (i.e. tutors), clients, admins and learners to track the detailed user performance. Coaches can motivate and provide fast one-to-one feedback through strength evolution as well as other results graphs and tables.

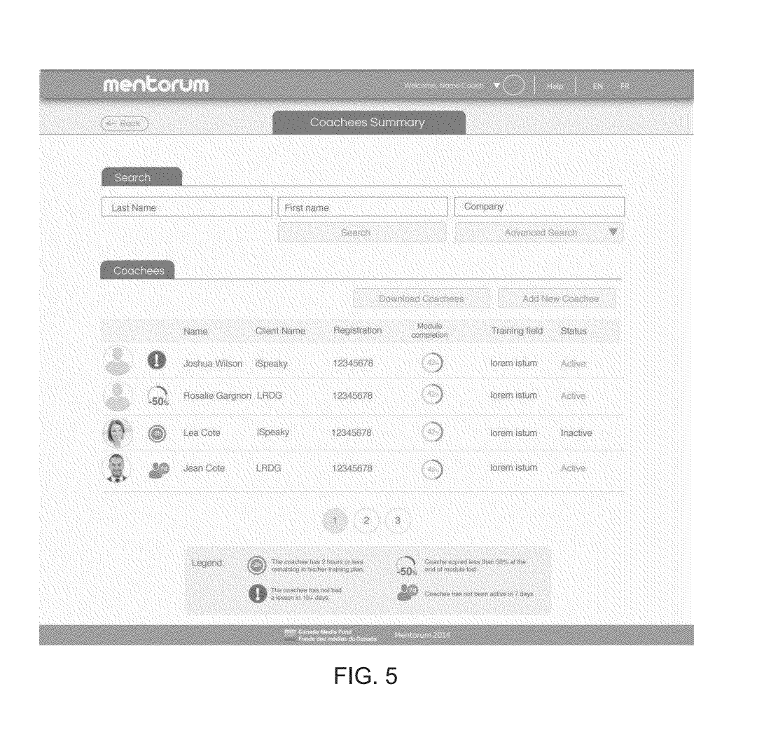

Presented in FIG. 5 is a screen snapshot of an instructor device user interface, according to one embodiment.

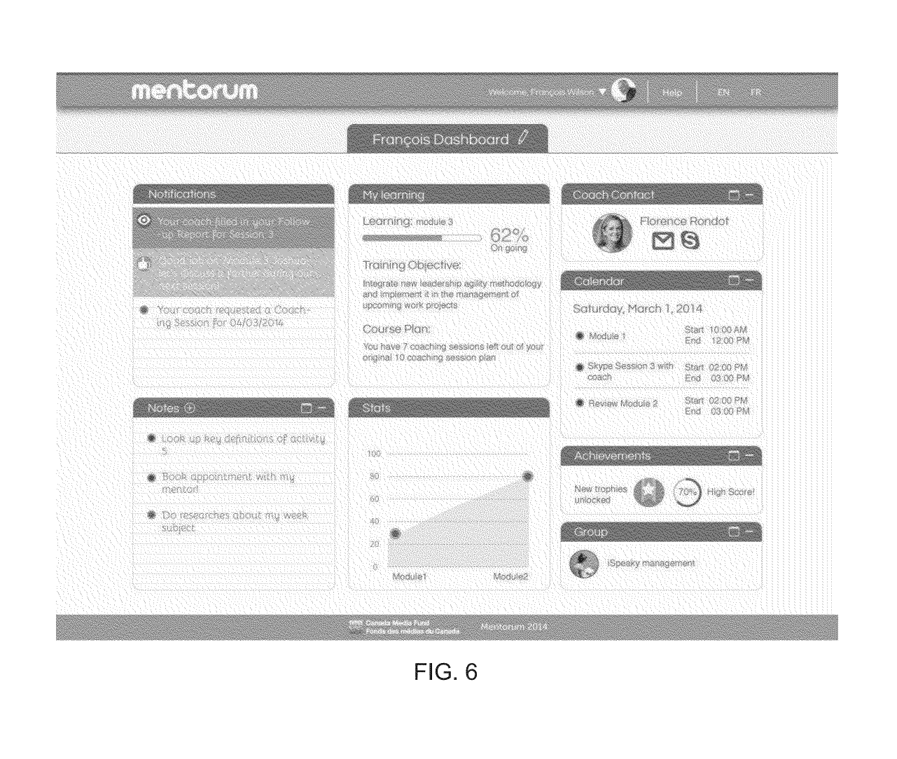

Presented in FIG. 6 is a screen snapshot of a student device user interface, according to one embodiment.

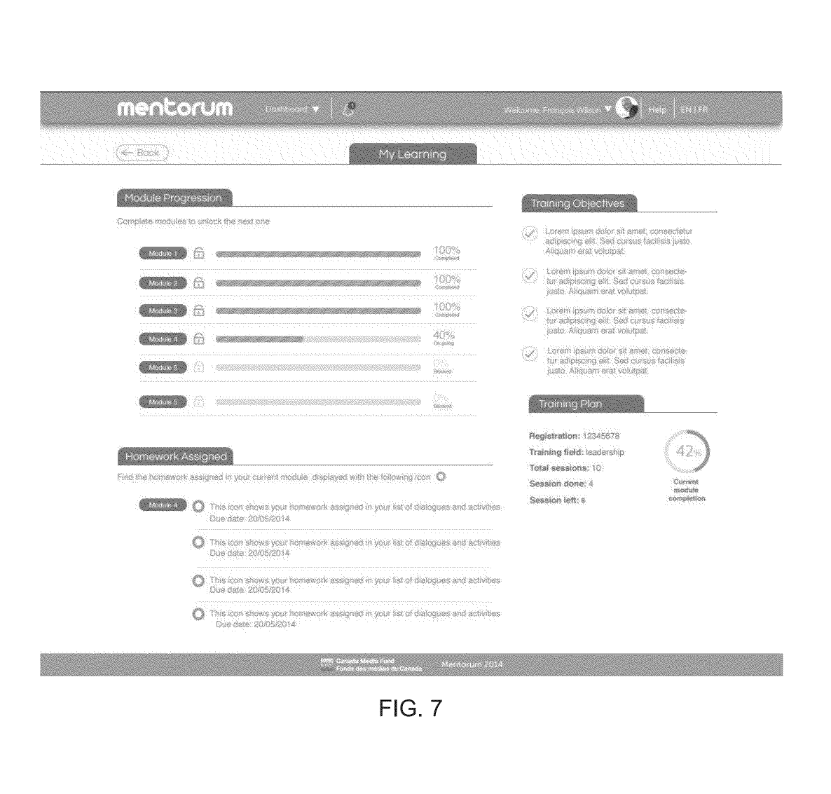

Presented in FIG. 7 is a screen snapshot of a training path, according to one embodiment.

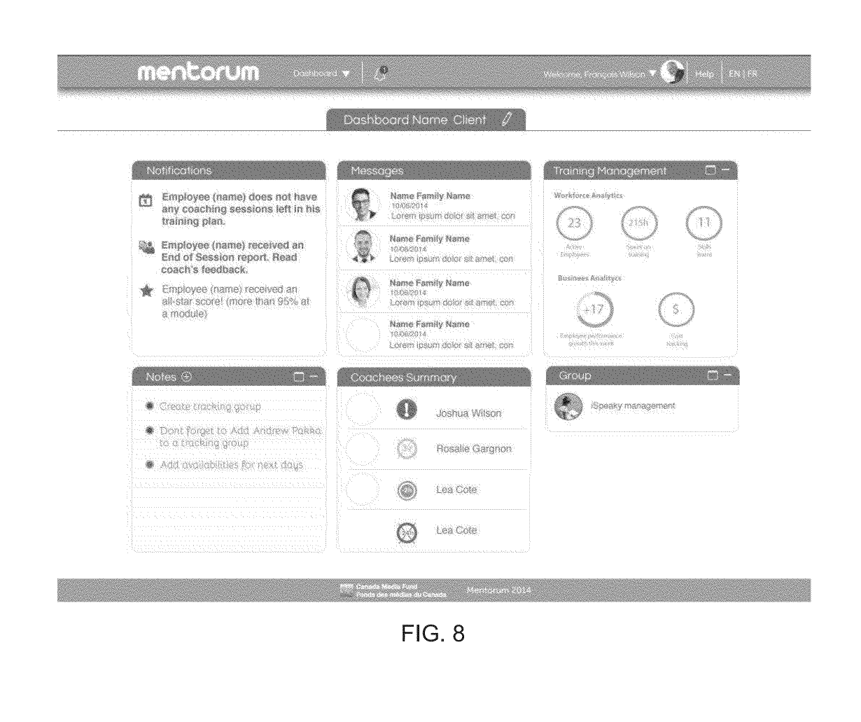

Presented in FIG. 8 is a screen snapshot of a client (ie. company) device user interface, according to one embodiment.

### Mobile Application

FIG. 1, is a mobile application 160 (i.e. a mobile app) that supports the web based version of the learning management application 150 and is accessible by a learner 120, in this case the application 160 is called Linguatrack™. A learner can interact and use the learning content via the mobile application 160.

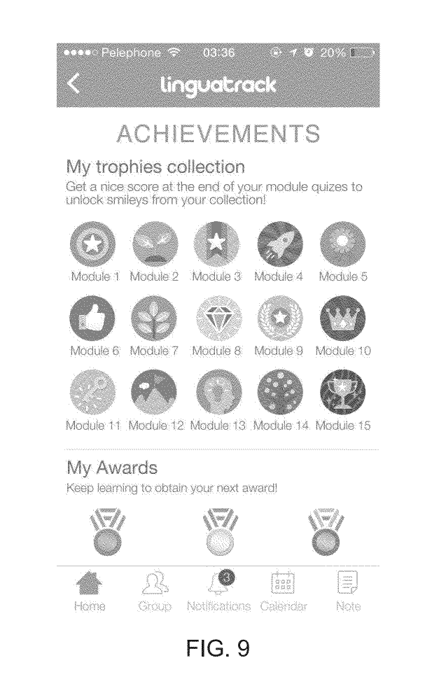

According to one embodiment, gamification is built into the application 160 and achievements such a trophies are awarded to learners for accomplishing specific goals. Presented in FIG. 9 is a screen snapshot of a learner device user gamification interface (Linguatrack iOS mobile Interface), according to one embodiment.

With the mobile application 160, a learner is able to track his progress for each individual module and view his overall results for specific skills since he started using the app 160 such as “leadership, grammar and spelling.” In one embodiment, there are several learning and testing templates that are provided by the app. In one mobile application 160, there are seventeen learning and testing templates that are provided 120.

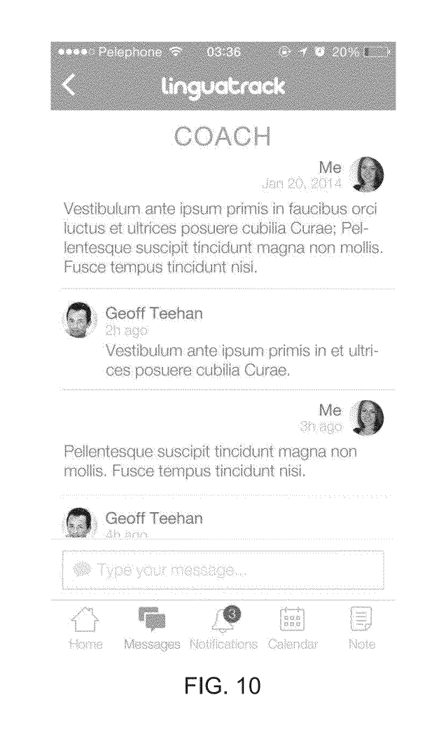

According to one embodiment, the mobile application 160 is adapted to provide a chatting tool in order to allow a learner to chat with his coach/tutor in real-time and also have group discussions with peers. Presented in FIG. 10 is a screen snapshot of a learner device user chatting interface (Linguatrack iOS mobile Interface).

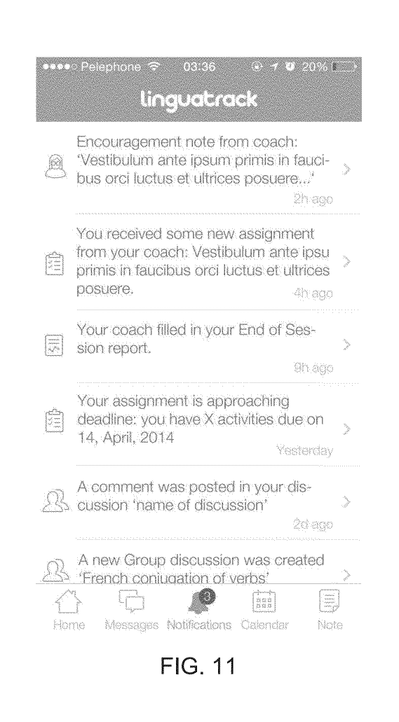

According to yet another embodiment, the mobile application 160 has a notification center adapted to notify the learner each time the coach provides feedback. The notification center notifies when an assignment is almost due. Presented in FIG. 11 is a screen snapshot of a learner device user notification interface (Linguatrack iOS mobile Interface).

### Content Management System (CMS) and Content Creation

The CMS is a user friendly way for a tutor or an administrator to upload learning content. Presented in FIG. 1 and according to one embodiment, an expert 170 in a particular discipline or domain creates related content 172 via an ontology editor 174, a referencing editor 176 and a multimedia tool 178. The content is then uploaded via a Content Management System (CMS) 140. Based on the uploaded content, a test can be provided to a learner 120 from a quiz repository module 148 and a cognitive diagnostic is established accordingly by the cognitive diagnostic module 102.

### How the Cognitive Diagnosis Service Works

According to one embodiment, the diagnostic process in question produces results that are exploitable under various circumstances according to specific needs. The specific needs can be established with human tutors and experts in the field. These results include:
1) A correlation matrix between the attributes. This structure allows analyzing how the attributes are correlated.
2) Estimated probabilities g, s and discrimination index (IDI) for each item.
3) Probabilities of success associated with each item in general or according to a learner profile.
4) Estimation of the learner's cognitive profile or class (i.e. probability of a specific profile according to a response pattern).
5) Structures for estimating the probability of mastering each attribute (i.e. estimation of the master level)
   a. for all learners; and
   b. for each learner—by presenting in a dashboard (from posteriori table of probability distribution);
6) A record-diagnostic built from previous elements for each learner.

### Bank of Items

The item bank contains all the items that cover the field. It may require calibration to ensure its consistency and semantic integrity (e.g. redundancy elimination, etc.). Some indicators of the proposed approach can suggest a review of the bank. For example, the value of probabilities g and s (see below) associated with an item are important indicators on its quality. It is the same with the discrimination index (IDI).

### Matrix

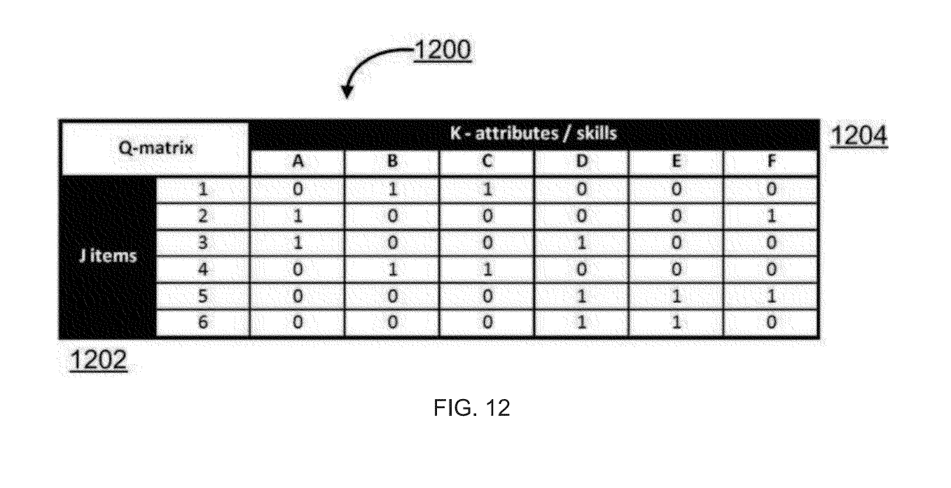

Presented in FIG. 12 is a matrix structure 1200 that is used by the cognitive diagnostic module 102 for representing a mapping between items 1202 and attributes 1204. The attributes 1204 can be indicative of abilities, knowledge, skills, mental processes or strategies. The cognitive diagnostic module 102 uses the matrix 1200 as a semantic referencing (i.e. indexing) tool. In the embodiment presented in FIG. 12, the matrix 1200 is called a Q-matrix. The matrix 1200 has a dimension of J×K where J corresponds to the number of items 1202 and K corresponds to the number of attributes 1204 measured in a domain. In one embodiment, an entry qⱼₖ of the matrix 1200 takes the value 1 if the attribute k corresponds to the item j and takes the value 0 otherwise:

qⱼₖ=1 if item j requires attribute k, or 0 else

For example, in the matrix 1200 of FIG. 12, item 5 requires attributes D, E and F; whereas attribute F is measured for items 2 and 5.

### Data (Database)

The cognitive diagnostic module 102 is further adapted to connect to a database having a data structure of N entries containing the responses of each of the N learners to the J items. The data structure may have any suitable form. In one instance the data structure is an array of N entries, each entry being a vector Vi of dimension J corresponding to a pattern of answers of an ith learner about J items. In another instance, the data structure is a matrix N×J in which each Xij value is 1 or 0 if a learner i succeeds or not at the item j.

### Default Model: DINA

The cognitive diagnostic module 102 is adapted to estimate a slip (s) element and a guess (g) element from the data of the data structure, as presented in Figure XX. The slip is indicative of the probability that a learner does not pass an item j when he has all the necessary skills. The guess is indicative of the probability that a learner succeeds at an item j even if he does not have at least one-associated attribute k. The cognitive diagnostic module 102 is adapted to estimate the slip and the guess indicators for each item based on a response pattern of each learner. A latent dichotomous variable is used to separate the learners in these two classes. This variable is calculated for each learner and for each item j. In one embodiment, the cognitive diagnostic module 102 uses a Deterministic Input Noisy Output (DINA) type model, a bit flag denoted ηᵢⱼ indicates for each item j that the learner profile i has all necessary attributes by using a “1” value or that the learner profile i has missed at least one required attribute by using a “0” value. The bit flag is defined as follows:

ηᵢⱼ=Πₖ₌₁^{k}αᵢₖ^{qjk}
αᵢₖ^{qjk} being the master level of the k-th skill by the learner profile i; and qⱼₖ being the entry of the Q-matrix specifying that the j-th item requires the k-th skill or not by using a “1” value or a “0” value respectively.

The estimation of the slip value (s) and the guess value (g) for each item is provided according to the following probabilities:

sj=P(Xij=0/nij=1),

gj=P(Xij=1/nij=0)
where Xij indicates that learner i has correctly answered or has incorrectly answered to item j (i.e. validity of a learner i response to item j).

Given η, s and g, the cognitive diagnostic module 102 is adapted to estimate the probability of a successful learner profile i to item j using the following formula:

P(Xij=1/αi,sj,gj)=(1−sj)ᵢⱼ^{η}gᵢⱼ^{1-η}

According to one embodiment, the cognitive diagnostic module 102 is adapted to also estimate the overall probability of success for each item j.

In yet another embodiment the cognitive diagnostic module 102 is adapted to calibrate items j 1202 and/or validate the matrix 1200 using an item discrimination index (IDI). The IDI is an index which value is an indicator of how the item j 1202 improves an estimation of the skills of the learner and distinguishes between those who have the necessary skills from those who do not possess them. Thus, the higher the IDI value, the better the discriminative quality of the item j 1202. The IDI value depends on the slip value and the guess value and is calculated as follows for each item: 1−gj−sj, where gⱼ is the guess probability associated with item j, and sᵢ is the slip probability. The higher the slip value and the lower the guess value, the better the IDI for an improved accuracy of the diagnostic related to the item. A perfectly discriminating item will have an IDI of 1 (i.e. a guess value of 0 and a slip value of 0).

### Integration in the Learning Engine

### Diagnostic

According to one embodiment, the cognitive diagnostic module 102 provides a diagnostic service that is adapted to use a posteriori probability distribution table. The table is a matrix structure of the form 2^{J}×2^{K}. The matrix structure represents a correspondence between a pattern of response to an item j 1202 for a number of 2^{K} cognitive profiles (or classes), J being the total number of items 1202 and K being the total number of attributes 1204. The matrix structure indicates the Pvw probability that a learner produces the pattern of response v which corresponds to a cognitive profile w (i.e. a binary vector of dimension K). A cognitive profile is indicative of the strengths (i.e. probably mastered skills) and weaknesses (i.e. probably unlearned skills) of a learner. Therefore a learner may or may not belong to a specific cognitive profile and a specific cognitive profile for a particular learner is therefore not a certainty. However, an overlap of cognitive profiles allows a high probability to issue a precise hypothetic diagnostic. The cognitive diagnostic module 102 uses a result interpreter to issue a precise hypothetic diagnostic based on the notions of support and confidence.

### Confidence and Support of a Classification

While a confidence level is the probability associated to a cognitive profile according to a pattern of response, a support level relates to the proportion (i.e. frequency) of learners who have produced such a response pattern. In one embodiment, a high confidence classification will have a higher significance if the corresponding response pattern has a high support. According to one embodiment, a filter is applied to the posteriori probability distribution table of patterns to eliminate infrequent responses. Response patterns that have a number that is below a predetermined threshold are considered as noise and are eliminated.

### Personalized Dashboard (Probability of Skill Acquisition in the Field)

According to one embodiment, the applications 150 or 160 are adapted to present a dashboard to the learner. The dashboard puts into perspective, for each learner, and for each skill, a mastering probability. The reporting module 106 of FIG. 1 is adapted to calculate a sum of probabilities associated with a response pattern of a learner (a line in the distribution table) according to an attribute 1204.

### Generation of a Diagnostic Record Cart

According to one embodiment, a diagnosis record is generated from the results with all the necessary details including a propagation of evaluation attributes in the ontological structure using (if any) a Mastery of domain Knowledge and competency Skills (MKS). The reporting module 106 of FIG. 1 is adapted to calculate the MKS based on test results, for each instance and ontology concept. The reporting module 106 first determines the ontology concepts of a domain for which the MKS is lower than a predetermined threshold. In addition the reporting module 106 is adapted to calculate a confidence level of the MKS value. The MKS for an instance is established based on a ratio of correct answers with respect to a total number of questions related to the instance in particular. Therefore for each concept of the ontology two measurements are calculated: the MKS and the level of confidence of the MKS. According to one embodiment, the MKS is calculated by applying an average to all the MKS measurements of all asserted and inferred instances. The MKS confidence level is calculated according to a ratio of the number of referenced instances and the total number of instances related to the ontology concept. The concepts for which the MKS measurement is lower than a predetermined threshold α are considered to be indicative of a lack of mastering the concept and could indicate a learning performance problem.

According to yet another embodiment, the reporting module 106 uses a DINA-H model, which uses a hierarchical structure of types and does not require an MKS propagation. In one example, a function (onto2hierachies) transforms the ontology into a bag of hierarchical structures of four types: divergent, convergent, sequential or unstructured. These structures allow substantially reducing the dimension of the vector of attributes and exploiting the semantic richness connected to their hierarchical structure.

### Features of the Approach

1) Integration of statistical approaches and Intelligent Tutoring Systems (ITS) approaches provides the power of statistical processing to estimate a set of mastered attributes using patterns of response and in depth diagnostics that go beyond a simple item diagnosis and extends to aggregates of items diagnosis. This integration of approaches also allows maintaining a learner's model in order to detect errors that are not related to a lack of knowledge.

2) Linking of attributes provides a linking of the attribute semantics through the ontology of the domain that structures them. This way, the attributes (i.e. skills, knowledge, strategies and mental processes) are defined and structured in a domain ontology, which not only allows exploiting the links between them but also allows in depth analysis (their properties being explicit) and inferring new axioms concerning them, for explaining the errors of the learner in the diagnostic record.

3) Managing the assessment of latent abstract attributes (those that are not directly linked to items). This is done in two ways: 1) by providing the MKS method to estimate the mastery levels of those attributes through an interpretation of semantic links that connect them and 2) by providing a function (into2hierachies) that transforms the domain ontology into a bag of hierarchies (of four types) which is then given as input for an automatic use of a DINA-H model to estimate those attributes. MKS method is defined as the default method in Aquila but the Aquila users can set the other approach if DINA-H is available.

### Development Plan and Integration Method in Aquila

A plan comprising the following steps:
1) Calibrating the bank of items and validating the ontology of the domain by the experts.
2) Developing the Q-Matrix from semantic item referencing (indexing) by the ontology of the domain; the attributes being the concepts of the ontology.
2′) optional: Use the onto2hierarchies function to build the bag of hierarchies required if using DINA(O)-H is an option.
3) Building or customizing a database containing response patterns from a reasonable number of learners.
4) Determining the appropriate Cognitive Diagnostic Model (CDM) (DINA, DINO, mixed DINA-DINO, DINA-H, DINO-H). This activity should be done quickly by training these models with the results of steps 2) and 3). Recommendation: Using the CDM package of R for estimating the indices -2LL, AIC and BIC associated with each model. Both a d1 model (DINA type) and a d2 (DINO type) can be estimated by performing a din function of the package and passing the data bank and the q-matrix parameter. This function builds each of the models according to the associated. It is then possible to compare the values -2LL, AIC and BIC associated with each model by calling the variance analysis function anova:
   >d1<-gdina (sim.dina, q.matr=sim.qmatrix, rule=“DINA”)
   >d2<-gdina (sim.dina, q.matr=sim.qmatrix, rule=“DINO”)
   >anova(d1,d2)

| Model | loglike | Deviance | Npars | AIC | BIC |
|---|---|---|---|---|---|
| 1 Model 1 | −2042.293 | 4084.586 | 25 | 4134.586 | 4234.373 |
| 2 Model 2 | −2086.759 | 4173.518 | 25 | 4223.518 | 4323.305 |

In this example, for the sim.dina dataset and q-Matrix sim.qmatrix dataset, the DINA model type is most appropriate since the associated values of AIC and BIC are smaller and the -2LL value is greater.
5) Developing an integration strategy of the Aquila model.
6) Implementing the selected model by using the CDM package. Possible functions:
   Coef(d1): Displays the estimated parameters for each item with the model as a parameter and includes attributes associated with each item.
   d1$q.matrix: Returns the q-matrix from the d1 model.

| | V1 | V2 | V3 |
|---|---|---|---|
| [1,] | 1 | 1 | 0 |
| [2,] | 0 | 1 | 1 |
| [3,] | 1 | 0 | 1 |
| [4,] | 1 | 0 | 0 |
| [5,] | 0 | 0 | 1 |
| [6,] | 0 | 1 | 0 |
| [7,] | 1 | 1 | 1 |
| [8,] | 0 | 1 | 1 |
| [9,] | 0 | 1 | 1 |

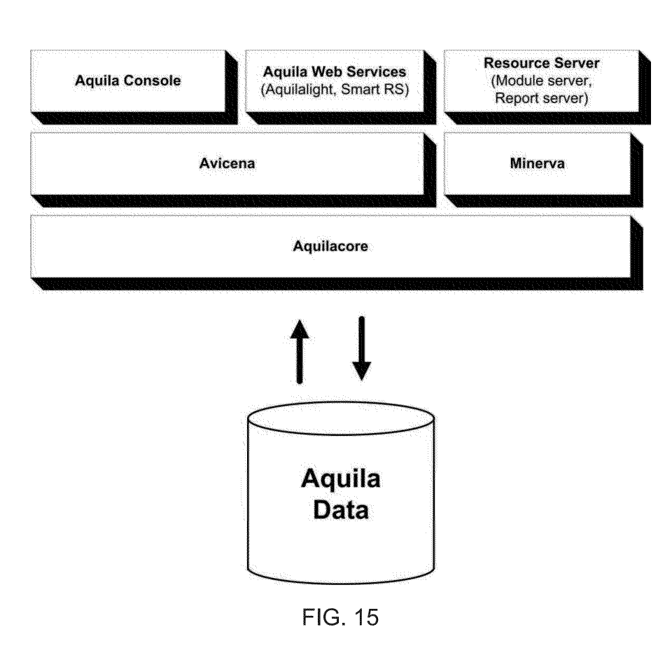

Summary (d1): Summarizes all variables estimated by the model.
d1$data: Returns the dataset of the model that is either a matrix N by J where N is the number of respondents and J is the number of items.
plot(d1): Displays a graph illustrating the probabilities associated to each profile class, as illustrated in FIG. 15.
round(d1$posterior): Extracts the table of probabilities posteriorly associated by linking each response pattern with a class profile in terms of belonging or non-belonging;
or round(d1$posterior, 2): Extracts the table of probabilities posteriorly associated by linking each response pattern with a class profile in terms of probability of belonging, which could be more accurate than “round(d1$posterior)”.
d1$attribute.patt: Estimates the probability of profile classes of the d1 model.
d1$pattern[1:5,]:Classifies individual profiles for each response pattern.
etc.
7) Developing a set of functions to produce the dashboard and the diagnostic record according to the model.
8) Testing and validating
9) Developing an automatic perfection mechanism of the database in order to allow an automatic re-assessment or re-adjustment of the model whenever necessary. The adjustment could even lead to a change of the model.

### How AQUILA's Smart Recommender System Works

Smart-RS is based provides a collection of recommendation services in the form of Web services. Each recommender implements one of the best known algorithms such as content-based recommendation (CBR), collaborative filtering recommendation (CFR) and Rule-based Filtering (RBF). These recommenders can be used separately or in combination with other recommenders thus allowing the design of integrated recommendation approach. In following, we describe the principles of each recommender.

1—Content-Based Recommender (CBR):

The CBR recommender can be requested under normal conditions of recommendation. However, a highly appropriate context of use would be finding an alternative resource to an original resource which for unknown reasons (e.g., network failure) becomes unavailable. In CBR recommender, only data on the active learner are used to recommend next activities. Learning activities (e.g., courses) are given descriptors such as name, keywords, abstract, etc. Hence, given a current activity, provided with its descriptors, the general mechanism consists in returning the best match among the proposed activities.

As mentioned above, for the time being, CBR is planned as technique that can help in finding a replacement for unavailable learning resources rather than first-class recommendation technique.

2—Collaborative Filtering Recommender (CFR):

Collaborative filtering (CF) is a technique used by several recommender systems, including ecommerce systems. In the context of such a technique, recommendation depends on learner's information and large number of learners. The goal is to predict the utility of an activity for the active user based on a database of rating data. It is noteworthy that learners rate activities. These ratings can be viewed as an approximate representation of the user's satisfaction of these activities. Partitions of learners are throughout the use of the recommender. Each partition is made of leaners with most similar learning difficulties.

Moreover, a rating matrix (table of two dimensions matrix: Skills×Activities) is constructed where each row in the table represents all the rates of one skill on all activities while each column in the table represents all the rates of all skills on one activity. The binary relation Row×Column shows how the activity is relevant to the apprehension of the skill Finally, statistical techniques (likeliness) are used to find the (active) learner partition, i.e., learners known as neighbors to the active learner. The recommendation technique consists in recommending activities that similar learners have rated highly but not yet being rated by this active learner.

TABLE 1
Skills × Activities

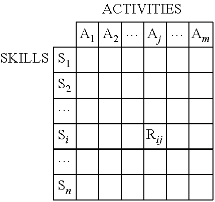

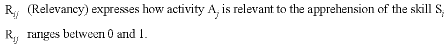

3—Rule-Based Filtering (RBF)

Rule-based filtering (RBF) relies on a set of rules which, in the context of Aquila TS, associates a set of skills to a set of activities that can help the learner in the acquisition of these skills To that end, a binary matrix is defined and used to learn rule basis using association rules algorithms (Note: In data mining, several algorithms are proposed that help extracting a set of implication rules such as those which rely on Formal Concept Analysis (FCA)). Hence, starting from target skills, recommender system uses the set of rules to filter out next activities. We introduce two techniques of RBF that use different filters as explained in next section.

3.1—Static Filter (Theoretical Relevancy-Driven RBF Recommender)

Static filter refers to constant set of filtering rules. Hence, beside domain concepts, a collection of skills are defined by domain experts and associated to the corresponding concepts. A two-dimensional matrix is defined by experts as illustrated in the table below.

TABLE 2
Skills × Concepts

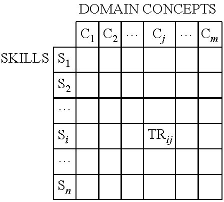

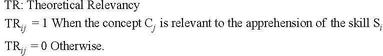

The table 1 is used to generate the theoretical rule base, which is used by the TR filter for RBF recommender.

3.2—Dynamic Filter (Empirical Relevancy-Driven RBF Recommender)

Dynamic filter refers to an ever-changing set of filtering rules. Through usage of the recommender system, new rules are added to the calculated filter to take into account successful recommendations.

To that end, we introduce the Empirical relevancy (ER), a new metric that is derived from Mastery of Knowledge and Skills (MKS) value which in turn is obtained from the quiz attempt (see the diagnostic approach).

Definition 1:

Given a concept C and the corresponding set A₁, A₂ . . . Aₙ of running activities (as indicated by the quiz attempt). Let MKS be the associated value of MKS that is returned by the diagnostic process of quiz attempt Qₖ, the empirical relevancy is calculated as follow:

$${ER}_{ij}^{k} = \frac{{MKS}^{k}}{n}$$

After each request of diagnostic, ER is updated in order to keep an average throughout the use of activities. Hence, after n diagnostic requests, the update is obtained as follow:

$${ER}_{ij} = \frac{1}{n} {\sum }_{k = 0}^{n} {ER}^{k}$$

TABLE 3
Activities × Concepts

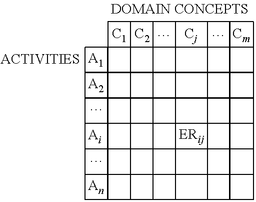

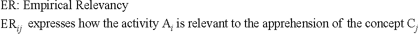

The table 3 is used to generate the empirical rule base which is used by the empirical relevancy filter for RBF recommender.

Of course, numerous modifications could be made to any of the embodiments described above. The scope of the claims should not be limited by the preferred embodiments set forth in the examples, but should be given the broadest interpretation consistent with the description as a whole.

What we claim is:

1. A computer-implemented system for cognitive predictions on skills and knowledge of a learner as disclosed in the present application.

2. A computer-implemented method for cognitive predictions on skills and knowledge of a learner as disclosed in the present application.

3. A computer-implemented process for cognitive and predictions on skills and knowledge of a learner, the process comprising the following steps:
1) building a domain ontology;
2) establishing a items bank;
3) referencing the items bank using elements from the domain ontology elements or semantic-grounding of the items;
4) establishing a training database of learners answers;
5) estimating Cognitive Diagnostic Model (CDM) parameters and determining an appropriate model to be used;
6) running the model to estimate a learner level on non-abstract latent variables;
7) applying a Mastery of domain Knowledge and competency Skill (MKS) approach to estimate the learner level on abstract latent variables, or extracting relevant hierarchies from the ontology and use the CDM appropriate model to estimate those attributes; and
8) building a diagnosis report from the results of steps 6) and 7).
